(19) United States
(12) Patent Application Publication
(10) Pub. No.: US 2023/0337822 A1
(43) Pub. Date: Oct. 26, 2023

(54) RECLINING SEAT MOUNT

(71) Applicant: Lippert Components, Inc., Elkhart, IN (US)

(72) Inventor: Douglas V. STEURY, New Paris, IN (US)

(21) Appl. No.: 18/139,713

(22) Filed: Apr. 26, 2023

Related U.S. Application Data
(60) Provisional application No. 63/335,132, filed on Apr. 26, 2022.

(51) Int. Cl. A47C 1/027

(52) U.S. Cl. CPC A47C 1/027

(57) ABSTRACT

A reclining seat mount is securable to a seat base with a reclining base structure for positioning between an upright position and an inclined position. The reclining seat mount includes a seat back with an inside portion and an outside portion, and a back frame cooperable with the seat back. The back frame includes a top portion engaging the outside portion of the seat back and a bottom portion engaging the inside portion of the seat back.

### CROSS-REFERENCES TO RELATED APPLICATIONS

This application claims the benefit of U.S. Provisional Pat. Application Serial No. 63/335,132, filed Apr. 26, 2022, the entire content of which is herein incorporated by reference.

### STATEMENT REGARDING FEDERALLY SPONSORED RESEARCH OR DEVELOPMENT

(NOT APPLICABLE)

### BACKGROUND

The invention relates to a reclining seat mount and, more particularly, to a marine seat reclining system with a rigid seat back structure pivotally mounted to a reclining base structure cooperable with a seat base.

Furniture in a marine environment can be challenging due to space and material requirements. It is desirable to include seating areas with reclining functionality. A design challenge for a reclining seat is to provide a structural configuration with sufficient strength to perform as intended without breaking and/or malfunction.

### SUMMARY

A marine seat reclining system according to the described embodiments includes a rigid seat back structure that is inserted into an opening and recess created in a seat back and secured with fasteners. The rigid seat back structure pivotally mounts to a reclining base structure secured underneath the seat base, which is also secured with fasteners. The reclining mechanism is mostly hidden from view and has the strength and rigidity to allow for a substantial seat recline without breaking.

In some embodiments, the rigid back structure is in the form of a back frame that is cooperable with the seat back and includes a top portion engaging the outside of the seat back and a bottom portion engaging the inside of the seat back. The reclining base structure is attached to the underside or to a side of the seat base and puts the leverage upward and outward on the seat base. The structure and the configuration of the back frame provide added strength to the configuration to achieve the reclining function without breaking.

In an exemplary embodiment, a reclining seat includes a seat back with an inside portion and an outside portion, a seat base, a reclining base structure fixed to the seat base, and a back frame coupled with the seat back and engaging the inside portion and the outside portion of the seat back. The back frame is connected to the reclining base structure.

The seat back may include a seat back opening therethrough, and the back frame may be positioned through the seat back opening. The seat back may include a recess in the outside portion, and the back frame may include a top portion that may be secured to the seat back in the recess. The back frame may include a bottom portion secured to the reclining base structure. The top portion of the back frame may include two metal frame bars welded to the bottom portion. The bottom portion of the back frame may include a connecting plate secured to the reclining base structure, and the two metal frame bars may be welded to the connecting plate.

The reclining base structure may be fixed to an underside of the seat base or to a side of the seat base.

The reclining base structure may include a connecting bracket to which the back frame is connected, and the connecting bracket may be pivotable between an upright position and an inclined position. In this context, the reclining base structure may be automated such that the connecting bracket is pivotable via a push-button or remote control.

In another exemplary embodiment, a seat back assembly securable to a seat base with a reclining base structure for positioning between an upright position and an inclined position includes a seat back with an inside portion and an outside portion, and a back frame cooperable with the seat back that includes a top portion engaging the outside portion of the seat back and a bottom portion engaging the inside portion of the seat back.

### BRIEF DESCRIPTION OF THE DRAWINGS

These and other aspects and advantages will be described in detail with reference to the accompanying drawings, in which:

FIG. 1 is an exploded perspective view of the reclining seat assembly according to an exemplary embodiment;

FIG. 2 shows the back frame and the seat back prior to connecting the back frame with the seat back;

FIGS. 3A-5B show a sequence of steps for securing the back frame to the seat back;

FIGS. 6 and 7 show exemplary configurations of the reclining base structure and the connection of the seat back to the reclining base structure;

FIG. 8 is a plan view of the reclining base structure; and

FIG. 9 is a rear view of the assembled reclining seat assembly.

### DETAILED DESCRIPTION

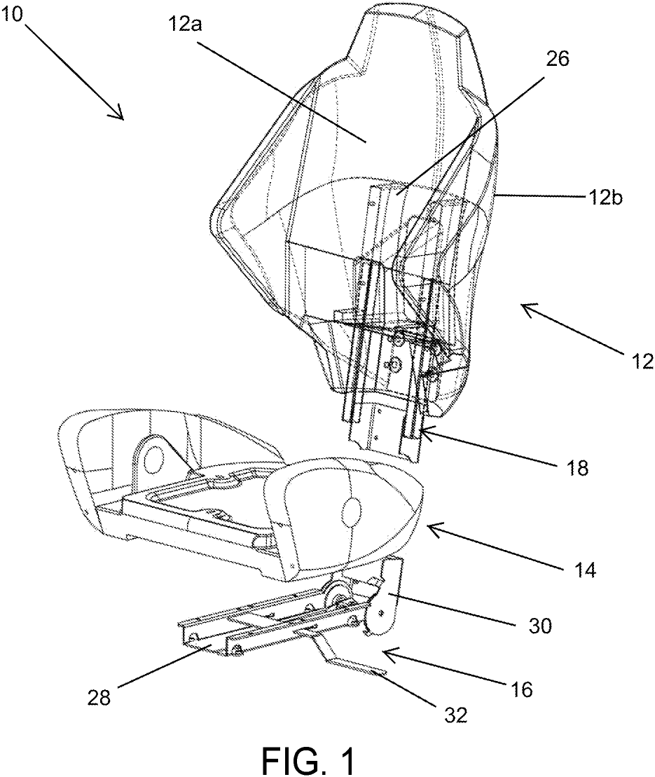

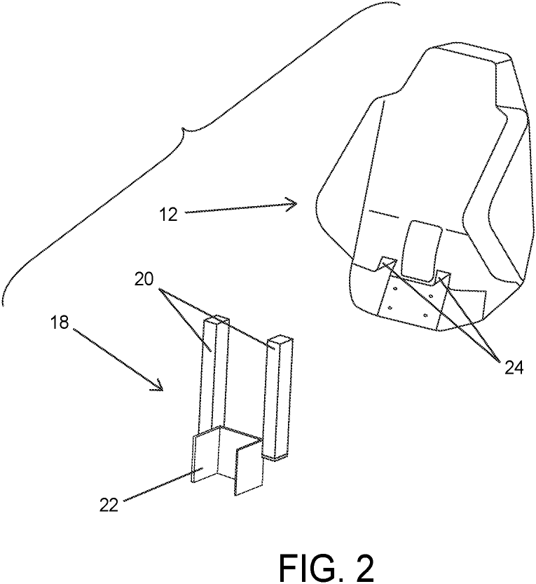

With reference to FIGS. 1 and 2, the reclining seat assembly 10 according to an exemplary embodiment includes a seat back 12 with an inside portion 12a and an outside portion 12b. The assembly 10 also includes a seat base 14 and a reclining base structure 16 fixed to the seat base 14. In some embodiments, the seat back 12 and the seat base 14 may be constructed via roto-molded plastic. A back frame 18 is coupled with the seat back 12 and is connected to the reclining base structure 16.

In some embodiments, the back frame 18 includes a top portion in the form of, for example, two metal frame bars 20. The back frame 18 also includes a bottom portion in the form of, for example, a connecting plate 22. In an exemplary construction, the metal frame bars 20 are welded to the connecting plate 22 to define a rigid back structure for the back frame 18.

The seat back 12 is provided with at least one seat back opening 24 therethrough. The seat back 12 also includes at least one recess 26 in the outside portion 12b. In some embodiments, the seat back 12 includes two recesses 26 that are sized and shaped to receive the frame bars 20 of the back frame 18.

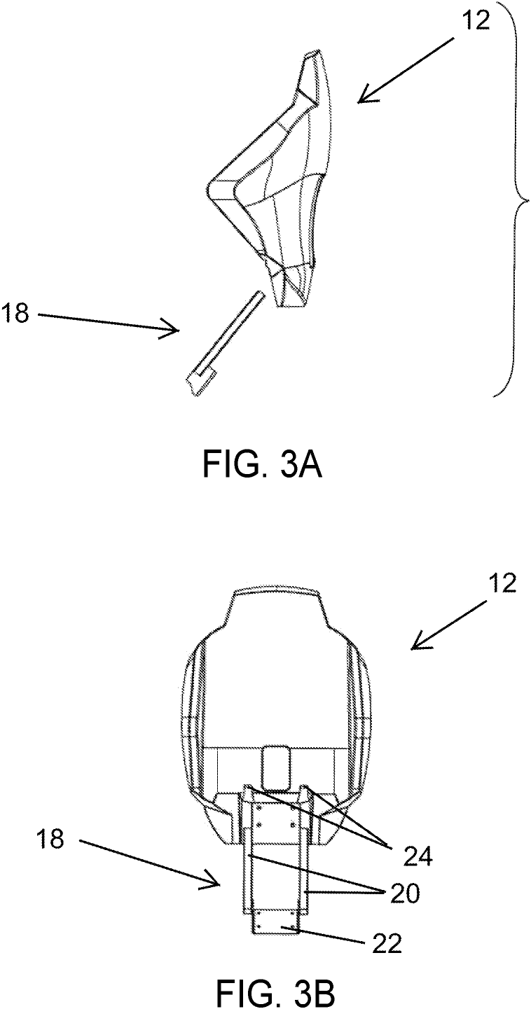

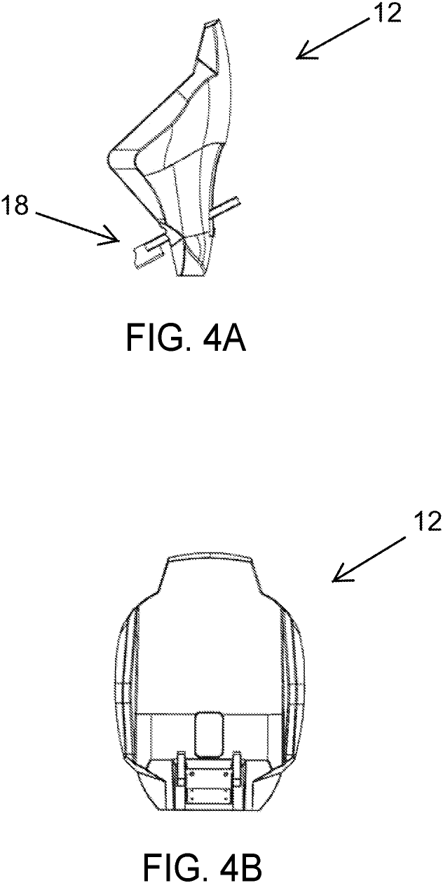

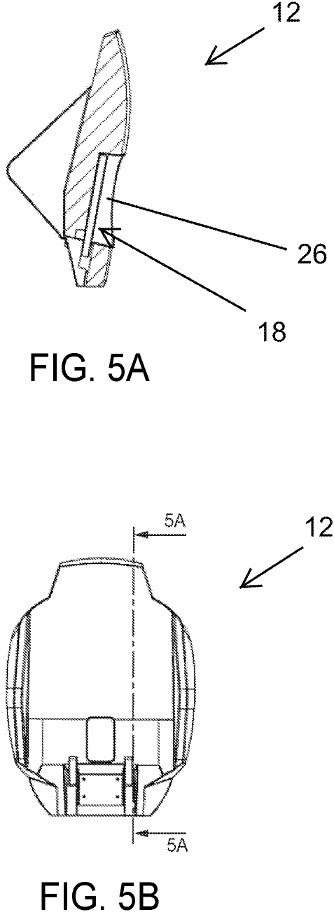

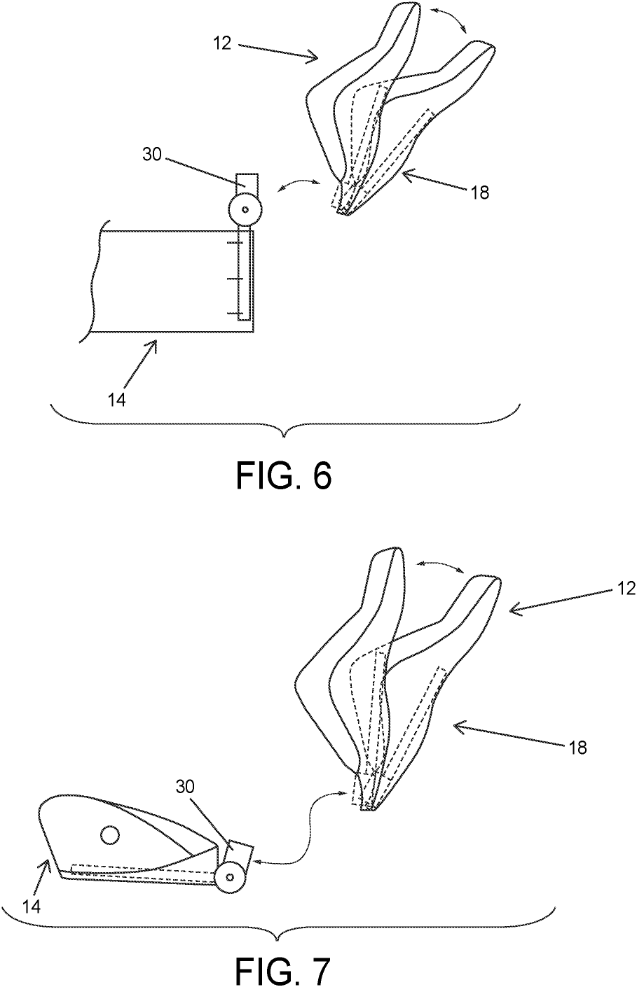

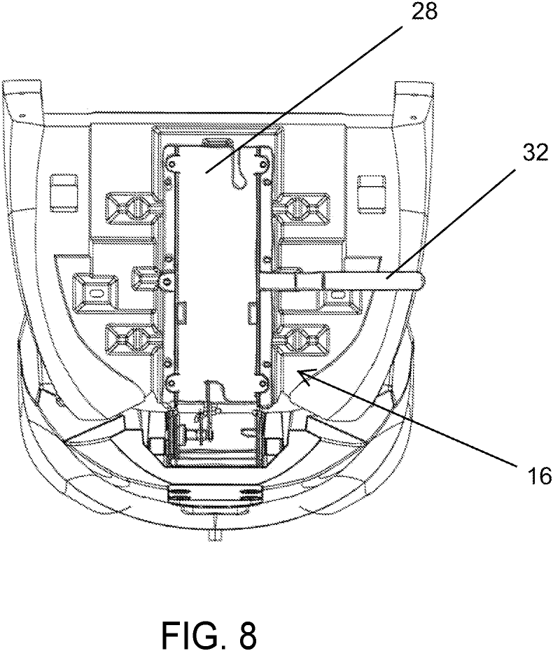

With reference to FIGS. 3A-5B, the back frame 18 is secured to the seat back 12 by first inserting the top portion or frame bars 20 through the openings 24 in the seat back 12 (see FIGS. 4A and 4B). The back frame 18 is pushed through the seat back 12 and is subsequently pivoted (counterclockwise in FIG. 5A) until the frame bars 20 engage the recesses 26 in the outside portion 12b of the seat back 12. The back frame 18 is then secured in place with mechanical fasteners or the like. The back frame 18 thus engages both the inside portion 12a of the seat back 12 and the outside portion 12b of the seat back 12.

The reclining base structure 16 is of known construction, and any suitable reclining base structure may be used. Generally, the reclining base structure 16 includes a fixing bracket 28 for securing the reclining base structure 16 to an underside or to a side of the seat base 14 and a connecting bracket 30 that is pivotable relative to the fixing bracket 28. The connecting bracket 30 is pivotable relative to the fixing bracket 28 between an upright position and one or more inclined positions. In some embodiments, the connecting bracket 30 is pivotable up to 45° relative to the fixing bracket 28. The connecting bracket 30 may be spring-biased toward the upright position. A lever 32 or other mechanism may be displaced to unlock the connecting bracket 30 for pivoting against the bias of the spring. The lever 32 may itself be spring-biased and can be released to lock the connecting bracket 30 in an inclined position. In alternative configurations, the connecting bracket 30 may be pivotable via a push-button or remote control activating an electric motor.

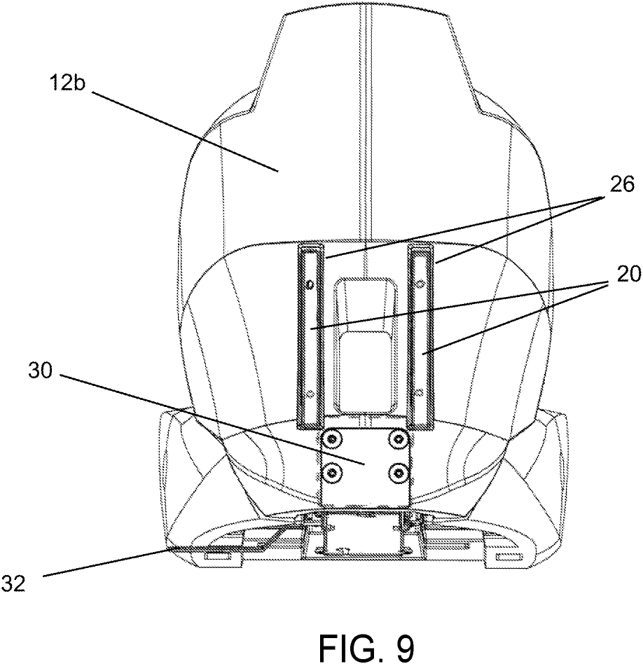

With the back frame 18 secured to the seat back 12, the bottom portion or connecting plate 22 of the back frame 18 is secured to the connecting bracket 30 of the reclining base structure 16 with mechanical fasteners or the like. See FIGS. 1 and 9.

In use, the seat back 12 can be reclined relative to the base 14 by displacing the lever 32 to unlock the connecting bracket 30 and applying a force against the seat back 12 that exceeds the bias of the spring acting on the connecting bracket 30. When the lever 32 is released, the assembly can be locked in the inclined position. In order to displace the assembly back to the upright position, the lever 32 can be displaced to unlock the connecting bracket 30, after which the spring bias will return the assembly to the upright position. With a motorized reclining base structure, the assembly may be simply displaced between the upright and reclined positions via a push-button or remote control.

The rigid back frame including a top portion engaging the outside of the seat back and a bottom portion engaging an inside of the seat back provides added strength to the assembly, thereby enabling the assembly to perform without breaking. The reclining base structure attached to the underside or side of the seat base shifts the leverage upward and outward relative to the seat base, thereby further enhancing the strength of the assembly.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A reclining seat comprising:
a seat back with an inside portion and an outside portion;
a seat base;
a reclining base structure fixed to the seat base; and
a back frame coupled with the seat back and engaging the inside portion and the outside portion of the seat back, the back frame being connected to the reclining base structure.

2. A reclining seat according to claim 1, wherein the seat back comprises a seat back opening therethrough, and wherein the back frame is positioned through the seat back opening.

3. A reclining seat according to claim 2, wherein the seat back comprises a recess in the outside portion, and wherein the back frame comprises a top portion that is secured to the seat back in the recess.

4. A reclining seat according to claim 3, wherein the back frame comprises a bottom portion that is secured to the reclining base structure.

5. A reclining seat according to claim 4, wherein the top portion of the back frame comprises two metal frame bars welded to the bottom portion.

6. A reclining seat according to claim 5, wherein the bottom portion of the back frame comprises a connecting plate that is secured to the reclining base structure, and wherein the two metal frame bars are welded to the connecting plate.

7. A reclining seat according to claim 4, wherein the bottom portion of the back frame comprises a connecting plate that is secured to the reclining base structure.

8. A reclining seat according to claim 3, wherein the top portion of the back frame comprises two metal frame bars.

9. A reclining seat according to claim 1, wherein the reclining base structure is fixed to an underside of the seat base or to a side of the seat base.

10. A reclining seat according to claim 1, wherein the reclining base structure comprises a connecting bracket to which the back frame is connected, and wherein the connecting bracket is pivotable between an upright position and an inclined position.

11. A reclining seat according to claim 10, wherein the reclining base structure is automated such that the connecting bracket is pivotable via a push-button or remote control.

12. A seat back assembly securable to a seat base with a reclining base structure for positioning between an upright position and an inclined position, the seat back assembly comprising:
a seat back with an inside portion and an outside portion; and
a back frame cooperable with the seat back, the back frame including a top portion engaging the outside portion of the seat back and a bottom portion engaging the inside portion of the seat back.

13. A seat back assembly according to claim 12, wherein the seat back comprises a seat back opening therethrough, and wherein at the top portion of the back frame is positioned through the seat back opening.

14. A seat back assembly according to claim 13, wherein the seat back comprises a recess in the outside portion, and wherein the top portion of the back frame is secured to the seat back in the recess.

15. A seat back assembly according to claim 14, wherein the bottom portion of the back frame is securable to the reclining base structure.

16. A seat back assembly according to claim 15, wherein the top portion of the back frame comprises two metal frame bars welded to the bottom portion.

17. A seat back assembly according to claim 16, wherein the bottom portion of the back frame comprises a connecting plate that is securable to the reclining base structure, and wherein the two metal frame bars are welded to the connecting plate.
